(19) United States
(12) Patent Application Publication
(10) Pub. No.: US 2006/0169219 A1
(43) Pub. Date: Aug. 3, 2006

(54) Automatic dog washing system

(76) Inventors: Philip Yaghmai, Long Beach, CA (US); Peter Jeziorek, Mountain View, CA (US); Tom Yeh, Cambridge, MA (US); Jerome Lee, Irving, TX (US)

Correspondence Address: BEEM PATENT LAW FIRM, 53 W. JACKSON BLVD., SUITE 1352, CHICAGO, IL, 60604-3787, US

(21) Appl. No.: 11/048,190

(22) Filed: Feb. 1, 2005

(51) Int. Cl. A01K 29/00

(52) U.S. Cl. 119/651

(57) ABSTRACT

A method and apparatus for washing a dog by means of agitation. The agitation is accomplished by placing the dog in a whirlpool of warm water, which periodically reverses direction, therefore creating the same type of scrubbing effect as in a home washing machine, but without a solid agitator shaft in the middle or any solid bodies touching the dog. Soap and conditioner may be dispensed into the whirlpool at various times during the process to assist in further cleaning and conditioning depending on which type of cleaning cycle the operator chooses on a control panel.

### BACKGROUND OF THE INVENTION

1. Field of the Invention

The present invention is directed to an automatic dog washing system adapted to wash a dog by means of agitation.

2. Description of Related Art

In the U.S. alone there are approximately 43,000,000 households with little alternative to the manual washing of their dogs-often a burdensome labor. Our goal is to create an automatic dog-washing apparatus designed specifically with convenience in mind. This document describes a system that safely cleans different-sized dogs with minimum owner effort.

What is needed is a non-bulky and easy-to-use dog washing system.

### BRIEF SUMMARY OF THE INVENTION

It is therefore an object of the present invention to provide a non-bulky and non-cumbersome dog washing system.

In accordance with the present invention, a dog washing system comprises a method and apparatus for washing the dog by means of agitation. The agitation is accomplished by placing the dog in a whirlpool of warm water, which periodically reverses direction, therefore creating the same type of scrubbing effect as in a home washing machine, but without a solid agitator shaft in the middle or any solid bodies touching the dog. Soap and conditioner may be dispensed into the whirlpool at various times during the process to assist in further cleaning and conditioning depending on which type of cleaning cycle the operator chooses on a control panel.

### BRIEF DESCRIPTION OF THE SEVERAL VIEWS OF THE DRAWINGS

In the figures

FIG. 1 is an exploded perspective view of a dog washing apparatus in accordance with one aspect of the invention

FIG. 2 is a side elevation of the dog washing apparatus of FIG. 1.

FIG. 3 a side elevation of the dog washing apparatus of FIG. 1.

FIG. 4 is a perspective view of an adjustable height stool of the dog washing apparatus of FIG. 1.

FIG. 5 is a top perspective view showing a restraint of the dog washing apparatus of FIG. 1.

FIG. 6 is a top perspective view showing a splash cover of the dog washing apparatus of FIG. 1.

FIG. 7 is a top perspective view of a fluid distribution housing and pump and valve components of the dog washing apparatus of FIG. 1.

FIG. 8 is a top perspective view of a tub of the dog washing apparatus of FIG. 1.

FIG. 9 is an enlarged view of a portion of the adjustable height stool of FIG. 4.

FIG. 10 is a diagrammatic showing of a washing cycle.

FIG. 11 is a diagrammatic showing of a state diagram of a controller.

### DETAILED DESCRIPTION OF THE INVENTION

General System Overview

A goal of this system is to wash the dog by means of agitation. The agitation is accomplished by placing the dog in a whirlpool of warm water, which periodically reverses direction, therefore creating the same type of scrubbing effect as in a home washing machine, but without a solid agitator shaft in the middle or any solid bodies touching the dog. Automatic soap and conditioner are dispensed into the whirlpool at various times during the process to assist in further cleaning and conditioning depending on which type of cleaning cycle the operator chooses on the control panel. In a more scientific sense, the actual agitation is a combination of shear force exerted by the water acting on the dog's body and diffusion. The current of the whirlpool creates a moment, and reversal of the direction the turbulence to increases agitation, and therefore the scrubbing effect. The maximum agitation necessary to clean the dog during a certain amount of time is yet to be determined and will require experimentation with different sized pumps and jets.

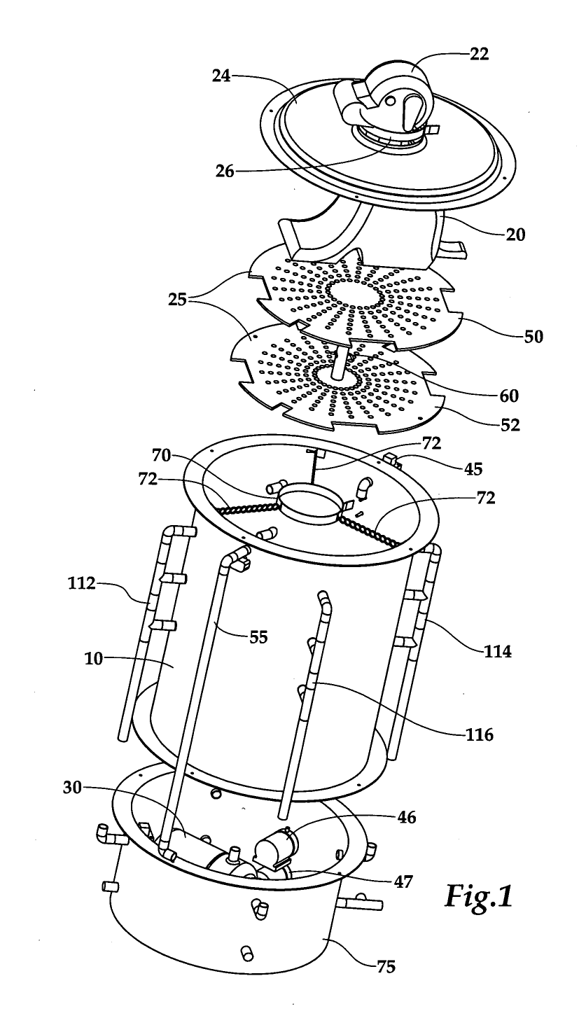

The apparatus, seen in FIGS. 1, 2 and 3, is a tub or container 10 with angled jets 12, 14, 16, 18 (see FIG. 8) that provide a whirlpool current.

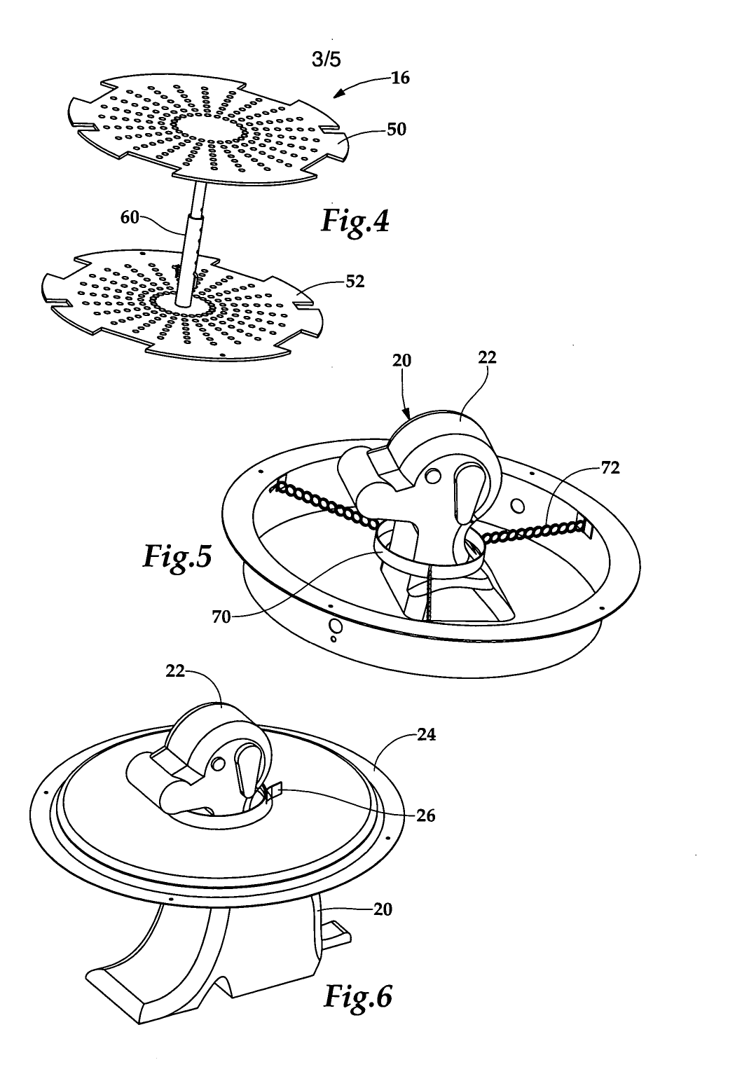

The dog 20 is to be placed on an adjustable height stool 16 (FIG.4) to keep the dog's head 22 from submersion into the water.

Users will have multiple washing levels to choose from, and also an option for conditioning the dog's hair. The parameters of the levels are based upon the size of the dog—small, medium, or large—and the length of the dog's hair—short or long. Once these parameters have been specified, the washing process can begin. The washing process will occur in three basic cycles—wetting, washing, and rinsing. Each cycle involves filling the tub with new water and maintaining a constant water level with a whirlpool. A pump 30 provides the mechanism that produces the whirlpool current. Two solenoid valves 32, 34 along with the pump allow for the whirlpool currents' reversibility.

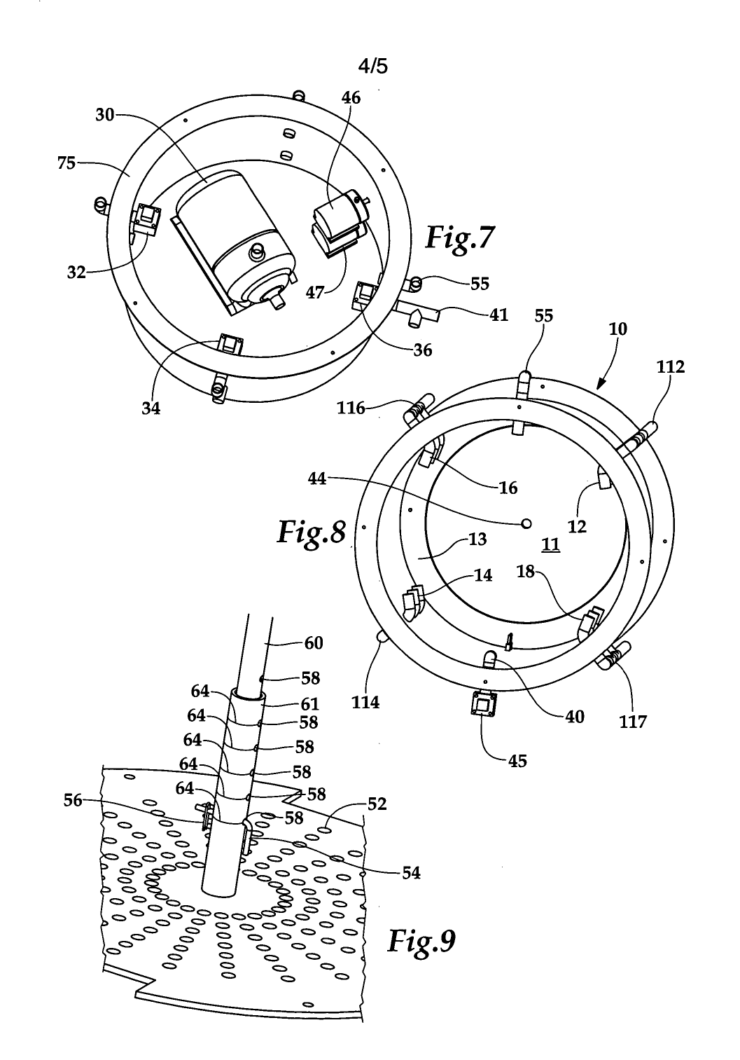

As valve 32 (FIG.7) turns on, the water gets pumped through pipes 112, 114 into two sets of jets 12, 14 (FIG. 8) that are angled tangential to the wall of the tub 10. These two jet sets 12, 14 are located diagonally opposite to one another to create a clockwise rotation (as viewed in FIG. 8) of the water in the tub 10. When valve 34 (FIG. 7) is switched on, water is pumped to two different sets of jets 16, 18 than the ones 12, 14 for valve 32, but with similar construction, only designed to create counterclockwise water rotation. After each cycle (wetting, washing, rinsing, etc.), the water is pumped out of the system. The cycles differ in their respective lengths of time. For example, the washing and rinsing cycles may be considerably longer than the wetting cycle, which is mainly for flushing out loose dirt and debris before the actual wash.

The washing cycle involves the addition of soap during the agitation process. The user will put soap into a soap reservoir prior to starting the wash processes, and the soap may then be added to the system either manually or automatically by means of a small pump or dispenser mechanism. The rinsing cycle may be repeated several times in order to achieve the optimal cleaning. This will remove all excess dirt and soap from the dog and the system. Once all rinsing cycles are completed, the dog may be removed from the washer for drying. A conditioner may be added if desired, in the rinse cycle, in similar fashion to the soap in the wash cycle

Mechanical Systems

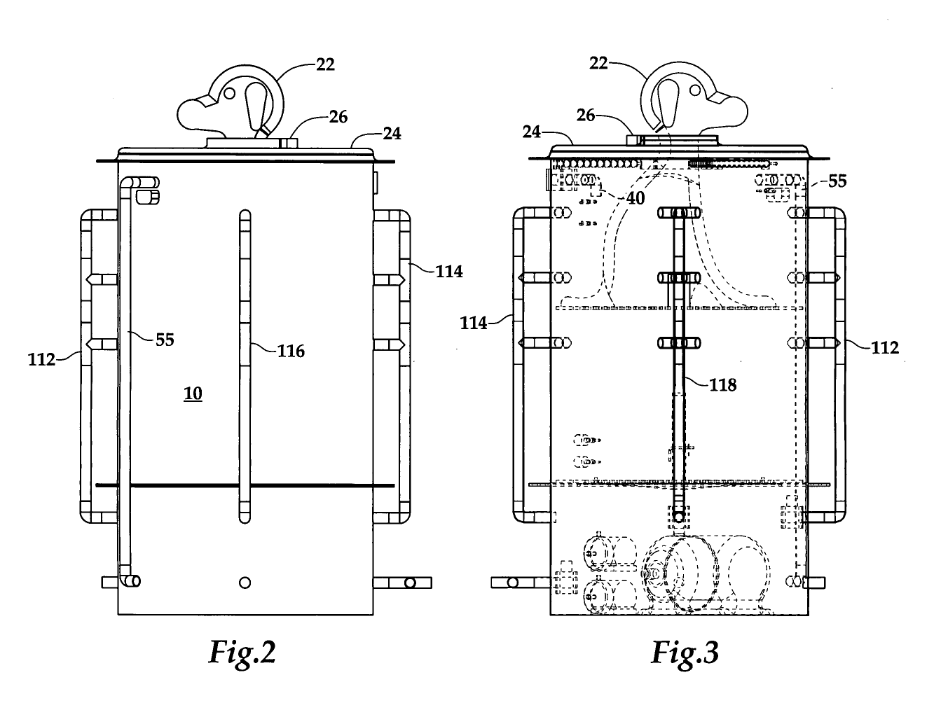

Washtub (FIGS. 1 and 2)

The washtub 10 is a cylinder having a generally conical bottom 11 for drainage, that will provide a container for the wash water, the stool, and the dog. A rim 13 surrounds the bottom 11 to support the stool 16. It will be important to minimize the amount of energy that is dissipated into the washtub by the vortex of water from the jets 12, 14 and/or 16, 18 while maximizing the energy working on the dog. This can be accomplished by having a high degree of hydrophobicity on the surface of the tub. The best material and construction of the washtub, subject to the cost constraints on the system is yet to be determined.

Interface to Source

The interface to the source of water variable as is the temperature of the source. The system may be provided with an interface to draw in hot and cold water, and the control of the temperature of the water will be accomplished by controlling valves that determine the degree of water-intake from the hot and cold sources. If bathroom, kitchen, or garage taps are used the interface will accept water from the tap, and the user will control the temperature of the water. An outdoor source of water, such as a hose, will use an interface to the hose, and the temperature of the water will be internally controlled within the system with a heater. In order to use other bodies of water, like a lake, stream or pond a hose with a filter will allow the pump to draw water, and the temperature of the water will be internally controlled within the system with a heater. The type of water source(s) to be used will drive the design of the interface(s) to the source(s) and the means of maintaining the temperature of the water.

Fill Pipe

Referring to FIG. 8, one or two fill pipe(s) 40 may be used to fill the tub; one pipe if the water source is premixed; two pipes if hot and cold-water sources are separate. The opening of the fill pipe is directed toward the tub bottom in order to avoid contact with the dog in case the water coming out the pipe is initially too cold or too hot. Using a separate fill pipe as opposed to the jets 12, 14 and/or 16, 18 will provide for easier maintenance and speed up the filling process due to minimized pressure loss. An overfill return pipe 55 prevents overfilling of the tub.

Pump

The pump 30 (FIG. 7) provides the pressure drop that will drive the flow of water into the jets 12, 14 and/or 16, 18, as well as to fill and empty the tub. This pressure drop is directly related to the angular velocity of the whirlpool. The higher the pressure drop, the higher the angular velocity. The angular velocity of the whirlpool, in turn, determines the shear force acting on the body of the dog. This shear force will wash the dog by pulling away at the dirt molecules and oils on the dog's body. By controlling the pressure drop in the pump, we can control the amount of agitation the dog experiences.

Jets

The jets 12, 14 and/or 16, 18 are the mechanism by which a vortex, or a whirlpool is created. Two systems of water jets will be placed on the tub. Each system is made up of two sets of jets that are angled tangential to diameter of the water in the tub. The two jet sets of each system are located diagonally opposite to one another and point to opposite directions so to create a rotational movement in the tub water. One system of jets 12, 14 creates a clockwise and the other set 16, 18 creates a counter clockwise tub water rotation. This is to allow for current reversibility and therefore agitation. The jets are aimed at an angle nearly tangent to the rim of the tub in order to maximize the angular velocity of the whirlpool created. It is yet to be determined whether adjusting the number and/or the size and/or exit velocity of the jet will affect the linear momentum.

Drainpipe

The drainpipe 41 will allow for used water to be drained out of the system via the pump 30 and a tub bottom drain 44.

Adjustable Height Stool

The dog washer is capable of accommodating multiple dog sizes. Currently, we propose to use a single sized tub, and we do not plan on making the heights of the jets adjustable. However, these things could be done in order to save on water, soap, and conditioner and to reduce the total wash cycle. Thus to ensure that each dog's head is situated at the same height with respect to the tub bottom and above the water fill level, an adjustable height stool mechanism 25 is used. The height level of the stool 50 is adjusted manually by the user of the system, and possibly even with the dog sitting on top of it.

We currently propose using a locating pin and safety pin mechanism 54, 56 (FIG. 9) and a set of telescoping center posts 60, 61 having alignable through holes 58. The stool height can be adjusted prior to insertion into the tub by using markers 64 provided on its bottom post to accommodate various dog neck heights from the floor while in a seated position. A base 52 of the stool will also function as a strainer. It is also possible to use automatic actuation systems such as a power screw, spring and lock, or a submersible or non-submersible motorized system. The stool construction will be of the lightest weight material, so it can be inserted and removed from the tub with minimum effort. Also, expanded or perforated non-skid construction will be used for maximized drainage and minimum slippage, therefore maximize cleanliness and flow due to its non-obstructive design.

Restrainer

The restrainer 70 will hold the dog in position in the pool of water that is washing it so that it will not jump out of the tub without supervision. The design is simply an adjustable and padded dog collar 70 and three lightweight chains 72, which are attached to the tub and the collar. One or more of these chains can be easily detached in order to allow the dog to be put in the tub. This design allows for multiple neck sizes.

Splash Cover

The splash cover 24 is constructed of a transparent, flexible (i.e. tarp) and hydrophobic material that is semi permanently fastened to the tub, and has an adjustable opening on top that can be strapped around the dog's neck with a strap 26 made of Velcro or the like in order to stop the water and soap form splashing out.

Housing

A suitable housing (not shown) will contain the electronic/control systems (see below) and will provide the structure within which to mount all of the above described parts of the dog washing system. Ideally the housing will be light enough for easy maneuverability.

Electronic Systems

Micro-Controller Unit

A micro-controller unit (not shown) is the brain of the system that controls different parts of the system electronically. It maintains the states of the system and responds to the input received by sensors.

Water Temperature Control

A water temperature control (optional, not shown) takes measurements from a temperature sensor and regulates the temperature to a predefined level by increasing or decreasing the proportion of cold/hot water mixture. If the measured temperature is below a predetermined value T, it decreases the ratio of cold to hot water intake. Likewise, if the measured temperature is above T, it increases the ratio of cold to hot water intake.

Cycle Control

A cycle control (not shown) starts and stops washing cycles by manipulating the valves and turning the pump on and off.

Water Level Sensor

A water level sensor (not shown) serves the purpose of signaling the system when the tub has been filled up to the maximum level, just below the dog's neckline.

Cycles are to Commence After Signaling.

Osverfill Return Pipe

An overfill pipe 55 returns any overflow from the top of the tub back into the drain. This is to avoid over flow spills in case of a fill system failure.

Temperature Sensor

A temperature sensor (not shown) would be used to ensure the water is neither too hot nor too cold.

Timer

A timer (not shown) measures the duration of each cycle. When the timer expires, the system can stop the cycle by draining the water from the tank.

Counter

A counter (not shown) counts the number of cycles the system has run.

Fill Valve

Referring to FIG. 8 a fill valve 45 is a solenoid-operated valve. It controls the water flow from the water supply source into the fill pipe. When the system is not in use its default position is “OFF.” At this position, no water is allowed to pass. When the system starts, the valve turns to “ON,” or “FILL” position to allow the water to enter the tub to be filled to the designated water level at which time it is turned to “OFF” position.

Drain Valve

Referring to FIG. 7 a drain valve 36 is a solenoid-operated valve. It controls the water flow from the pump into the drainpipe. When the system is not in use, its default position is “OFF.” At this position, no water is allowed to pass. It is turned to “ON” and “OFF” positions, as draining is needed.

Valve 32

Valve 32 creates whirlpools clockwise (C.W.) direction (looking from the top) during various cycles by allowing the water flow from the clockwise jets from one side of the tub, through the pump into the clockwise jets on the other side of the tub.

Valve 34

Valve 34 creates whirlpools counter clockwise (C.C.W.) direction (looking from the top) during various cycles by allowing the water flow from the counter-clockwise jets from one side of the tub, through the pump into the counter-clockwise jets on the other side of the tub.

Metering Pump

A metering pump 46 is used to meter out a specified amount of soap into the tub as it is called for.

Metering Pump 2

A second metering pump 47 is used to meter out a specified amount of conditioner into the tub as it is called for.

Mounting

The electronic system will be mounted on the housing. The mount will isolate the electronics from the mechanical vibrations and leaking water.

Software Control Scheme

This section outlines one scheme of operation of the system by the micro-controller unit.

I. User Prompt

A. Turns the system ON/OFF

B. Sets washing options (i.e. level of washing, number of cycles, etc.)

II. Filling the Tub

A. Checks to make sure Valves 32, 34, and 36 are in “OFF” position

B. Switches Valve 45 to “ON” or “FILL” position

C. Turns on the pump 30 (This process will only take place for particular water sources, i.e., a reservoir in order for water to rapidly fill the tub. Otherwise, the pump will not be used for filling.)

D. Senses the max water level condition

E. Switches Valve 45 to “OFF”position

III. Starting the washing cycle

A. Checks to make sure Valves 45, 36, and 34 are in “OFF” position

B. Turns Metering pump 46 (soap pump) “ON.” This step will not be in the manual soap dispensing machines.

C. Switches Valve 32 to “ON” position

D. Leaves Valve 32 “ON” for a preset period

E. Switches Valve 32 to “OFF” position

F. Switches Valve 34 to “ON” position

G. Leaves Valve 34 “ON” for a preset period

H. Repeats steps A-G as needed

IV. Draining the System

A. Occurs at the end of all cycles

B. Timer measures the cycle time length. Each cycle time will include a C.W. and C.C.W. rotations

C. When the time expires, switches Valve 36 to “ON or “Drain” position
1. Terminates water recycling processes for disposal of used-water
2. Water level sensor signals when tub is empty
   V. Restarting the Cycle

A. Counter indicates number of cycles to run

B. Turns system off upon completion of all cycles

VI. Other cycles

A. Wetting cycle removes loose dirt and filth from dog prior to the washing cycle

B. Rinsing cycle removes excess dirt and soap from the dog and the system after the washing cycle

C. Conditioning cycle applies conditioner to the dog's hair and works the same as the washing cycle except that it will be the last cycle prior to final rinse.

Alternative Software Control Scheme

This section outlines another embodiment of some of the possible operational objectives of the micro-controller unit which controls and coordinates the components to produce the desired system behaviors.

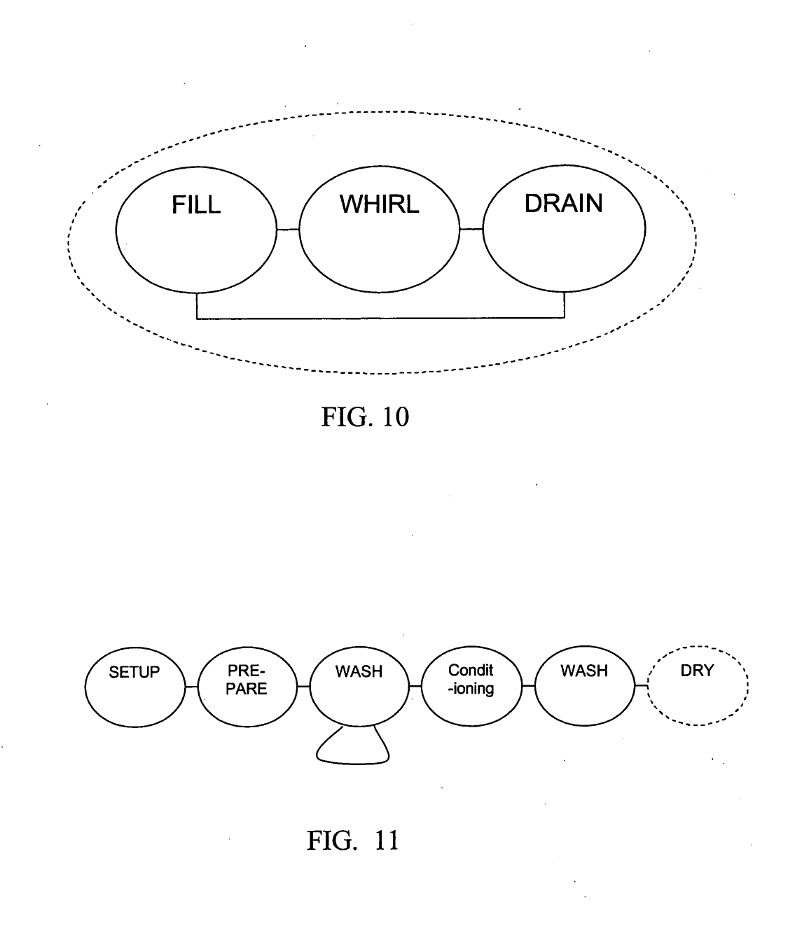

An important feature of the washing apparatus is the use of agitation to provide cleaning effects. The agitation occurs during the washing cycle which can run from 1 to N times depending on the degree of dirtiness. A typical washing cycle is divided into three steps: FILL, WHIRL, and DRAIN (FIG. 10). The control scheme for each step is outlined as follows:

Fill

1. Checks to make sure Valves 32, 34, and 36 are in “OFF” position
2. Switches Valve 45 to “ON” or “FILL” position
3. Turns on the pump 30 (This process will only take place for particular water sources, particularly, a larger reservoir source in order for water to rapidly fill the tub. Otherwise, the pump will not be used to draw water into the system from a source.
4. Senses the max water level condition
5. Switches Valve 45 to “OFF” position
   Whirl
1. Checks to make sure Valves 45, 36, and 34 are in “OFF” position
2. Turns Metering pump 46 (soap pump) “ON.” This step will not be in the manual soap dispensing machines.
3. Switches Valve 32 to “ON” position
4. Leaves Valve 32 “ON” for a preset period
5. Switches Valve 32 to “OFF” position
6. Switches Valve 34 to “ON” position
7. Leaves Valve 34 “ON” for a preset period
8. Repeats steps A-G as needed
   Drain
1. Occurs at the end of all cycles
2. Timer measures the cycle time length. Each cycle time will include a C.W. and C.C.W. rotations.
3. When the time expires, switches Valve 36 to “ON or “Drain” position
   Terminates water recycling processes for disposal of used-water
   Water level sensor signals when tub is empty
4. The current of the whirlpool creates a moment, and reversal of the direction the turbulence to increases agitation, and therefore the scrubbing effect. The current of the whirlpool periodically reverses direction (counter-clockwise and clockwise rotations) causing a turbulence that enhances the scrubbing effect.

FIG. 11 illustrates the state diagram of the micro control unit. First it enters the setup mode to allow the user to set operation parameters such as the number of washing cycles. Then, prior to the washing, a prepare cycle is run to wet the dog—removing loose dirt and filth from the dog, and add soap. Afterward, the system repeats a predefined number of washing cycles as determined from the user parameters set during the setup mode. A timer is used to measure the duration of each washing cycle. A counter is used to keep track of the number of washing cycles it has run. Before the last washing cycle, the system enters the conditioning cycles to apply conditioner to the dog's hair. The last washing cycle serves the purpose of final rinsing of the dog. At the end, the user can optionally choose to enter the drying cycle.

Conclusion

The objective of this apparatus is simple—to provide a safe, efficient, and effective means to wash dogs automatically. A dog owner, caretaker, or groomer will only have to add soap, or conditioner into a reservoir, set a few parameters according to the dog's needs, and start the processes. Upon completion of all washing processes, the dog should be thoroughly cleansed by means of agitation. Moreover, as an inherent bonus the jets within the tub will provide a massage action on the dog during all whirling processes.

The invention is claimed as follows:

1. An automatic animal washing system comprising:
a container for containing a quantity of liquid;
a plurality of jets for agitating said liquid;
a pump for delivering liquid under pressure to said plurality of jets, and
a control system for selecting a predetermined washing cycle, including a sequence of filling and emptying said container and a sequence of operation of said jets.

2. The system of claim 1, and further including a positioning apparatus for positioning an animal within said container at a desired height relative to a liquid level within said container.

3. The system of claim 2, and further including a restrainer for limiting movement of said animal relative to said container

4. The system of claim 1, wherein said container is generally cylindrical and wherein said jets are provided in two sets, and positioned so as to direct liquid in a direction generally tangent to a cylindrical wall of said container, each of said two sets comprising at least two jets located generally diagonally opposite the other.

5. The system of claim 2 wherein said positioning apparatus comprises an adjustable height platform submersible within the liquid in said container.

6. The system of claim 3, wherein said a restrainer comprises an adjustable size collar and a plurality of leads attachable between said collar and said outer wall of said container.

7. The system of claim I wherein said control system comprises a programmable microcontroller.

8. The system of claim 4 wherein one of said two sets of jets faces in a clockwise direction and the other of said two sets of jets faces in a counterclockwise direction

9. The system of claim 8, wherein said control system comprises a plurality of valves operatively coupled with said pump and said jets and a controller for operating said valves in a sequence for alternatively directing water through jets facing in said clockwise direction for a predetermined period of time and then directing water to the jets facing in said counterclockwise direction for a predetermined period of time, and for repeating said sequence a predetermined number of times.

10. The system of claim 8, wherein said control system comprises at least one dispenser valve for operating said valves in a sequence for dispensing a quantity of at least one of soap and conditioner

11. A method for washing animal in an automated fashion, said method comprising:
positioning said animal in a container at a predetermined height;
restraining said animal;
washing said animal in a predetermined, controlled cycle, including filling said container with a liquid, agitating the liquid in said container and emptying the liquid from said container in a predetermined sequence, and.
repeating said cycle a predetermined number of times.

12. The method of claim 11, wherein the step of positioning comprises adjusting the height of an adjustable height platform so that a head portion of the animal is above a predetermined filled level of liquid in said container.

13. The method of claim 11, wherein said predetermined, controlled cycle includes a fill portion, a whirl portion, and a drain portion.

14. The method of claim 13, wherein said fill portion and includes actuating a fill valve to an on position, while retaining one or more other valves in an off position; activating a pump; sensing said predetermined filled level, and switching said fill valve to an off position.

15. The method of claim 13, wherein said whirl portion comprises switching at least one valve to an on position for a predetermined period of time for delivering water from a pump to at least two sets of jets, each said set comprising at least one jet, for agitating liquid within said container.

16. The method of claim 13, wherein said drain portion comprises switching a drain valve to an on position at the end of said whirl portion sets when the level liquid in said container reaches an emptying level, and switching said drain valve to an off position when said container is empty.

17. The method of claim 15, wherein said whirl portion further includes dispensing a quantity of at least one of soap and conditioner into said container, prior to said switching of said at least one valve.

18. The method of claim 15, wherein said switching said at least one valve includes a first switching step comprising switching a first valve to an on position and a second valve to an off position, for a predetermined period of time for delivering liquid to at least one jet facing in a clockwise direction a second switching step comprising switching said first valve to off position and said second valve to an on position for a predetermined period of time for delivering liquid to at least one jet facing in a counterclockwise direction, and repeating said first and second switching steps a predetermined number of times.
